(19) United States
(12) Patent Application Publication
(10) Pub. No.: US 2024/0257011 A1
(43) Pub. Date: Aug. 1, 2024

(54) RISK ASSESSMENT METHOD AND SYSTEM FOR WINDAGE YAW FLASHOVER, DEVICE, AND READABLE STORAGE MEDIUM

(71) Applicants: State Grid Electric Power Research Institute In Shandong Province Power Company, Jinan, Shandong (CN); State Grid Corporation Of China, Beijing (CN)

(72) Inventors: Chao ZHOU, Jinan, Shandong (CN); Hui LIU, Jinan, Shandong (CN); Jiafeng QIN, Jinan, Shandong (CN); Xiaobin SUN, Jinan, Shandong (CN); Ran JIA, Jinan, Shandong (CN); Dandan LI, Jinan, Shandong (CN); Bo GENG, Jinan, Shandong (CN); Yang ZHANG, Jinan, Shandong (CN); Rong LIU, Jinan, Shandong (CN); Hao SHEN, Jinan, Shandong (CN); Chuanbin LIU, Jinan, Shandong (CN); Chuanwei YU, Jinan, Shandong (CN); Jie YANG, Jinan, Shandong (CN); Yingming CAI, Jinan, Shandong (CN); Xingyan CHEN, Jinan, Shandong (CN); Chengcheng GAO, Jinan, Shandong (CN); Likun WEI, Jinan, Shandong (CN)

(21) Appl. No.: 18/557,552

(22) PCT Filed: Aug. 28, 2023
(86) PCT No.: PCT/CN2023/115169

§ 371 Date: Oct. 26, 2023

(30) Foreign Application Priority Data
Nov. 4, 2022 (CN) 202211375747.6

(51) Int. Cl. G06Q 10/0635; G06Q 10/0639; G06Q 50/06

(52) U.S. Cl. CPC G06Q 10/0635; G06Q 10/0639; G06Q 50/06

(57) ABSTRACT

Provided is a risk assessment method for power transmission line windage yaw flashover. The method includes determining the influence factors of power transmission line windage yaw flashover and setting risk assessment indexes according to the influence factors (S101); generating the standard cloud of the risk assessment indexes according to the incident occurrence probabilities and the consequence levels of the risk assessment indexes (S103); scoring the influence factors according to the risk assessment indexes and generating the risk cloud of the risk assessment indexes according to scoring results (S105); and performing a two-dimensional similarity calculation on the risk cloud and the standard cloud to obtain two-dimensional similarity between the risk cloud and the standard cloud and determining the risk level of the power transmission line windage yaw flashover according to the two-dimensional similarity (S107).

This disclosure claims priority to Chinese Patent No. 202211375747.6 filed with the China National Intellectual Property Administration (CNIPA) on Nov. 4, 2022, the disclosure of which is incorporated herein by reference in its entirety.

### TECHNICAL FIELD

The present application relates to the field of power system technology, for example, a risk assessment method and system for power transmission line windage yaw flashover, a computer device, and a computer-readable storage medium.

### BACKGROUND

Power transmission lines and facilities of power grids are widely distributed in different geographical positions, and their operation environments are greatly affected by different meteorological conditions in different geographical positions. Line tripping caused by power transmission line windage yaw flashover is one of the important factors affecting the normal operation of power transmission lines.

At present, a power transmission line windage yaw flashover risk assessment proposes various risk assessment methods. For example, a Monte Carlo method is used to sample a meteorological region and a power transmission line to obtain the state of a power transmission element and perform a power system risk assessment, which has good applicability to meteorological conditions having relatively great randomness. For another example, a method for calculating the tripping probability of a power transmission line in a power system is established based on a Poisson distribution model and regression analysis, and a line is analyzed by a probabilistic method.

However, the current windage yaw flashover risk assessment technology still has the following disadvantages: 1. The preceding risk assessment windage yaw research mostly calculates the windage yaw angle of a single device and rarely calculates and analyzes the probability and risk value of windage yaw tripping, and as a result, the risk assessment is not universally applicable; 2. the weighting proportion between subjectivity and objectivity is unbalanced, partial weighting tends to subjective expert opinions, and partial weighting tends to objective reality conditions; and 3. the preceding risk assessment does not sufficiently take into account the fuzziness of different assessment index boundaries.

### SUMMARY

Embodiments of the present application provide a risk assessment method and system for power transmission line windage yaw flashover, a computer device, and a computer-readable storage medium to solve the preceding technical problems in the background, so that the assessment of windage yaw flashover is more universal, and the assessment result is more reasonable.

According to a first aspect of the embodiments of the present application, a risk assessment method for power transmission line windage yaw flashover is provided.

The risk assessment method for power transmission line windage yaw flashover includes the steps below.

The influence factors of power transmission line windage yaw flashover are determined. Risk assessment indexes are set according to the influence factors.

The standard cloud of the risk assessment indexes is generated according to the incident occurrence probabilities and the consequence levels of the risk assessment indexes.

The influence factors are scored according to the risk assessment indexes. The risk cloud of the risk assessment indexes is generated according to scoring results.

A two-dimensional similarity calculation is performed on the risk cloud and the standard cloud to obtain two-dimensional similarity between the risk cloud and the standard cloud. The risk level of the power transmission line windage yaw flashover is determined according to the two-dimensional similarity.

According to a second aspect of the embodiments of the present application, a risk assessment system for power transmission line windage yaw flashover is provided.

The risk assessment system for power transmission line windage yaw flashover includes an index set module, a standard cloud generation module, a risk cloud generation module, and a risk level determination module.

The index set module is configured to determine the influence factors of the power transmission line windage yaw flashover and set the risk assessment indexes according to the influence factors.

The standard cloud generation module is configured to generate the standard cloud of the risk assessment indexes according to the incident occurrence probabilities and the consequence levels of the risk assessment indexes.

The risk cloud generation module is configured to score the influence factors according to the risk assessment indexes and generate the risk cloud of the risk assessment indexes according to the scoring results.

The risk level determination module is configured to perform a two-dimensional similarity calculation on the risk cloud and the standard cloud to obtain the two-dimensional similarity between the risk cloud and the standard cloud and determine the risk level of the power transmission line windage yaw flashover according to the two-dimensional similarity.

According to a third aspect of the embodiments of the present application, a computer device is provided.

The computer device includes a memory and a processor. The memory stores computer programs. When executing the computer programs, the processor performs steps of the preceding method.

According to a fourth aspect of the embodiments of the present application, a computer-readable storage medium is provided.

The computer-readable storage medium stores computer programs. When executing the computer programs, a processor performs steps of the preceding method.

### BRIEF DESCRIPTION OF DRAWINGS

The drawings, which are incorporated in and constitute a part of the specification, illustrate embodiments consistent with the present application and, serve to explain the present application together with the specification.

FIG. 1 is a flowchart of a risk assessment method for power transmission line windage yaw flashover according to an example embodiment.

FIG. 2 is a diagram illustrating the structure of a power transmission line windage yaw flashover risk assessment index system according to an example embodiment.

FIG. 3 is a flowchart of a SWARA method according to an example embodiment.

FIG. 4 is a diagram of a two-dimensional cloud according to an example embodiment.

FIG. 5 is a block diagram of a risk assessment system for power transmission line windage yaw flashover according to an example embodiment.

FIG. 6 is a diagram illustrating the structure of a computer device according to an example embodiment.

### DETAILED DESCRIPTION

The description and drawings below fully illustrate specific embodiments herein to enable those skilled in the art to practice the embodiments. Portions and features of some embodiments may be included in or substituted for portions and features of other embodiments. The scope of the embodiments herein includes the entire scope of the claims and all available equivalents of the claims. As used herein, the terms “first” and “second” are used merely to distinguish one element from another element without necessarily requiring or implying any actual relation or order between these elements. Actually, a first element can also be referred to as a second element, and vice versa. Furthermore, the term “comprising”, “including” or any other variant thereof is intended to encompass a non-exclusive inclusion so that a structure, apparatus, or device that includes a series of elements not only includes the expressly listed elements but may also include other elements that are not expressly listed or are inherent to such structure, apparatus or device. In the absence of more restrictions, the elements defined by the statement “including a . . . ” do not exclude the presence of additional identical elements in the structure, apparatus, or device that includes the elements. Embodiments herein are described in a progressive manner. Each embodiment focuses on differences from other embodiments. The same or similar parts in each embodiment can be referred to by each other.

As used herein, terms “longitudinal”, “transverse”, “above”, “below”, “front”, “back”, “left”, “right”, “vertical”, “horizontal”, “top”, “bottom”, “inside”, and “outside” are based on the orientation or position relations shown in the drawings, which are merely for facilitating and simplifying the description of the present invention. These relations do not indicate or imply that an apparatus or element referred to have a specific orientation and be constructed and operated in a specific orientation. In the description herein, unless otherwise specified and limited, terms like “mounted”, “connected to each other”, and “connected” are to be construed in a broad sense, for example, mechanically connected or electrically connected, internally connected between two components, directly connected to each other, and indirectly connected to each other via an intermediary. For those of ordinary skill in the art, specific meanings of the preceding terms may be construed according to specific circumstances. As used herein, unless otherwise noted, the term “a plurality of” means two or more.

As used herein, the character “/” indicates an “or” relation between the preceding and following objects. For example, A/B means: A or B.

As used herein, the term “and/or” is an association relation describing objects and indicates three relations. For example, A and/or B means: A, or B, or A and B.

It is to be understood that although various steps in the flowchart of are illustrated sequentially as indicated by arrows, the steps are not necessarily performed sequentially in the sequence indicated by the arrows. Unless expressly stated herein, there is no strict limit to the sequence in which the steps are performed, and the steps may be performed in other sequences. Moreover, at least a part of the steps in the figure may include a plurality of sub-steps or a plurality of stages. These sub-steps or these stages are not necessarily performed at the same time, but may be performed at different times. These sub-steps or these stages are also not necessarily performed sequentially, but may take turns with at least a part of sub-steps or stages of other steps, or may be performed alternately with at least a part of sub-steps or stages of other steps.

Each module in the device or system of the present application may be completely or partially implemented by software, hardware, and combination thereof. Each preceding module may be embedded in or independent of a processor in a computer device in a hardware form or stored in a memory in the computer device in a software form so that the processor can call and execute operations corresponding to each preceding module.

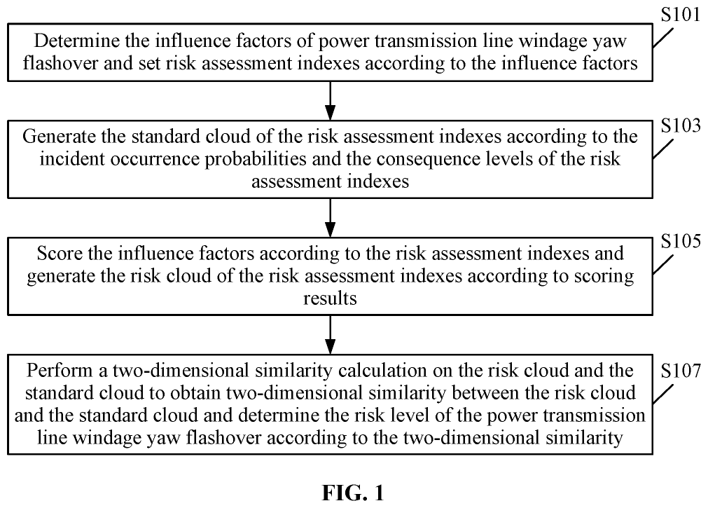

In the present application, FIG. 1 shows an embodiment of a risk assessment method for power transmission line windage yaw flashover according to the present application.

In this optional embodiment, the risk assessment method for power transmission line windage yaw flashover includes the steps below.
In step S101, the influence factors of power transmission line windage yaw flashover are determined, and risk assessment indexes are set according to the influence factors.
In step S103, the standard cloud of the risk assessment indexes is generated according to the incident occurrence probabilities and the consequence levels of the risk assessment indexes.
In step S105, the influence factors are scored according to the risk assessment indexes, and the risk cloud of the risk assessment indexes is generated according to scoring results.
In step S107, a two-dimensional similarity calculation is performed on the risk cloud and the standard cloud to obtain two-dimensional similarity between the risk cloud and the standard cloud, and the risk level of the power transmission line windage yaw flashover is determined according to the two-dimensional similarity.

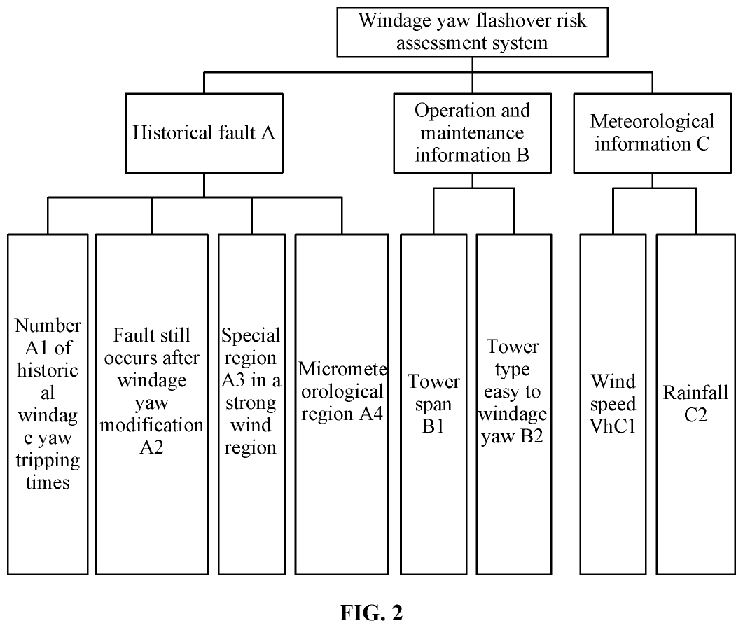

In an embodiment, the risk assessment method for power transmission line windage yaw flashover also includes determining the influence factors of the power transmission line windage yaw flashover according to the historical fault information, operation and maintenance information, and meteorological information of a power transmission line. As shown in FIG. 2, the risk assessment indexes determined according to the influence factors may be divided into three types of first level indexes and eight types of second level indexes.

In an embodiment, the influence factors are scored according to the risk assessment indexes, and the risk cloud of the risk assessment indexes is generated according to the scoring results in the following manners: An expert assessment system is generated according to the risk assessment indexes, and the weight values of the risk assessment indexes are calculated according to the expert assessment system; the risk assessment indexes are assessed according to the expert assessment system, and the initial risk cloud of the risk assessment indexes is generated according to assessment results; and the risk cloud of the risk assessment indexes is generated according to the weight values and the initial risk cloud.

In an embodiment, the weight values of the risk assessment indexes are calculated in the following manners according to the expert assessment system: The risk assessment indexes are sorted according to the expert assessment system, and comparing is performed according to risk assessment indexes of adjacent sequence numbers to obtain comparison results; the subjective weight values of the risk assessment indexes are determined based on a stepwise weight assessment ratio analysis method according to the comparison results; the risk assessment indexes are assessed according to the expert assessment system to obtain the assessment results; the assessment results are converted into intuitionistic fuzzy numbers, and the objective weight values of the risk assessment indexes are calculated based on a direct fuzzy entropy weight method; the comprehensive weight values of the risk assessment indexes are determined by a combined weighting method based on a game theory according to the subjective weight values and the objective weight values; and the comprehensive weight values are used as the weight values of the risk assessment indexes.

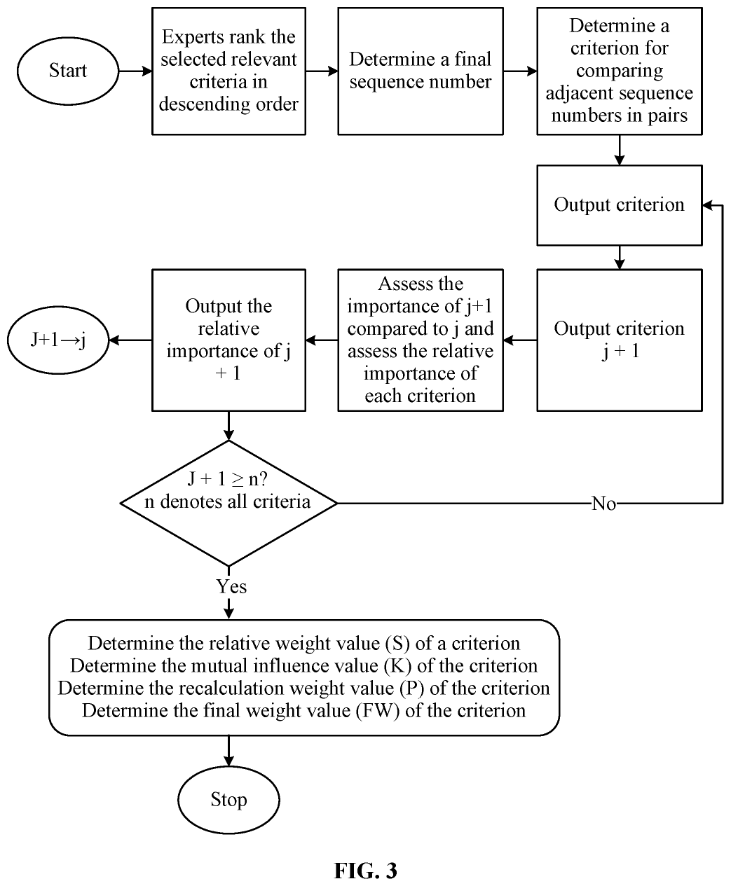

In the practical application, for the stepwise weight assessment ratio analysis (SWARA) method, the SWARA method has great advantages in terms of expert composition and calculation of a weight value. The main operation steps thereof are shown in FIG. 3. The main flow is as follows: Firstly, the initially prepared list of risk assessment indexes is distributed to experts, the risk assessment indexes selected by the experts are ranked in descending order of importance, the most important criterion is defined as level 1, and the least important criterion is defined as the last level (or level n); and the sequence number of each risk assessment index is the median of the sequence numbers ranked by all experts for the risk assessment indexes, that is, criterion j in FIG. 3. Secondly, the risk assessment indexes of adjacent sequence numbers are compared in pairs. The result of pairwise comparison is determined after multiple cycles. In this manner, the relative importance degree of each risk assessment index is assessed. Finally, the weight value of each risk assessment index is determined by calculation.

For example, firstly, the mutual influence value between various risk assessment indexes is determined. The calculation formula is: Kj=1&Kj=Sj+1, ∀ⱼ={2, . . . , n}. In the formula, Kj denotes the mutual influence value of a risk assessment index. Sj denotes the relative weight value of the risk assessment index. ∀ is a symbol in discrete mathematics and denotes any. n denotes the number of all risk assessment indexes. j denotes the jth risk assessment index. 1&Kj denotes K1=1 when j equals 1.

Secondly, the recalculation weight value of a risk assessment index is calculated according to the mutual influence value between various risk assessment indexes. The calculation formula is as follows:

$${P}_{j} = 1 \& {P}_{j} = \frac{{P}_{j - 1}}{{K}_{j}} {S}_{j} + 1 , \{ 2 , … , n \}$$

In the formula, Pⱼ denotes the recalculation weight value of the risk assessment index. Sⱼ denotes the relative weight value of the risk assessment index. Kⱼ denotes the mutual influence value of the risk assessment index. 1&Pⱼ denotes P₁=1 when j equals 1.

Secondly, the final weight value of the risk assessment index is calculated according to the recalculation weight value Pⱼ of the risk assessment index. The calculation formula is as follows:

$${FW}_{j} = \frac{{P}_{j}}{{\sum }_{k = 1}^{n} {P}_{k}} , {∀}_{j} ∈ \{ 1 , 2 , … , n \}$$

In the formula, FWⱼ denotes the final weight value of the risk assessment index. Pⱼ denotes the recalculation weight value of the risk assessment index. n denotes the total number of all risk assessment indexes.

For the intuitionistic fuzzy entropy weight method, the operation steps may be as follows.
1) The expert's language about an assessment object is converted into an intuitionistic fuzzy number. The language terms for rating the assessment object may be shown in Table 1 below.

TABLE 1
Language terms for rating the assessment object

| Assessment Language/Code | Intuitionistic Fuzzy Number |
|---|---|
| low risk | (0.8, 0.1, 0.1) |
| lower risk | (0.6, 0.3, 0.1) |
| medium risk | (0.45, 0.4, 0.15) |
| higher risk | (0.4, 0.5, 0.1) |
| high risk | (0.2, 0.7, 0.1) |

2) An original decision matrix is built. For the three types of first level indexes that cause windage yaw flashover, including historical fault information, operation and maintenance information, and meteorological information, an original decision matrix of m×8 is built. m denotes the number of second level indexes included in each first level index, and 8 denotes the number of assessment indexes. Experts (for example, k individuals) in the field of power transmission lines are invited to perform a level assessment on each index. Intuitionistic fuzzy theory is used for converting a level assessment language into an intuitionistic fuzzy number.

Assuming that the first level index is Dᵢ (i=1, . . . , m), the second level index is Cⱼ (j=1, . . . , n), and the expert is DMₖ (1, . . . , K), the intuitionistic fuzzy decision matrix of each expert is:

$${\tilde{X}}^{k} = [ \begin{matrix}( {μ}_{11}^{k} , {v}_{11}^{k} , {π}_{11}^{k} ) & ( {μ}_{12}^{k} , {v}_{12}^{k} , {π}_{12}^{k} ) & … & ( {μ}_{1 n}^{k} , {v}_{1 n}^{k} , {π}_{1 n}^{k} ) \\ ( {μ}_{21}^{k} , {v}_{21}^{k} , {π}_{21}^{k} ) & ( {μ}_{22}^{k} , {v}_{22}^{k} , {π}_{22}^{k} ) & … & ( {μ}_{2 n}^{k} , {v}_{2 n}^{k} , {π}_{2 n}^{k} ) \\ … & … & ⋱ & … \\ ( {μ}_{m 1}^{k} , {v}_{m 1}^{k} , {π}_{m 1}^{k} ) & ( {μ}_{m 2}^{k} , {v}_{m 2}^{k} , {π}_{m 2}^{k} ) & … & ( {μ}_{mn}^{k} , {v}_{mn}^{k} , {π}_{mn}^{k} )\end{matrix} ]$$

In the formula, (μₘₙ^{k}, νₘₙ^{k}, πₘₙ^{k}) denotes the intuitionistic fuzzy number of expert DMₖ for the first level index m and the second level index n. μ, ν, and π denote the membership degree, non-membership degree, and hesitation degree of the intuitionistic fuzzy number respectively. The relation between the three is 0≤μ+ν≤1, π=1−μ−ν.
3) The decision matrix is aggregated. The intuitionistic fuzzy decision matrix is aggregated into a group opinion. The formula is as follows:

$${\tilde{X}}_{ij} = IFWA ( {\tilde{X}}_{ij}^{1} , {\tilde{X}}_{ij}^{2} , … , {\tilde{X}}_{ij}^{K} ) = {λ}_{1} {\tilde{X}}_{ij}^{1} + {λ}_{2} {\tilde{X}}_{ij}^{2} + … + {λ}_{K} {\tilde{X}}_{ij}^{K}$$

In the formula, IFWA denotes an intuitionistic fuzzy weighted averaging operator. \tilde{X}ᵢⱼ^{K} denotes the intuitionistic fuzzy matrix obtained by the Kth expert. i and j denote the ith row and the jth column in the intuitionistic fuzzy matrix. λ_{K} denotes the weight of expert DMₖ, and the sum of its values is 1. Each value belongs to [0, 1]. K denotes the total number of experts. The aggregated intuitionistic fuzzy decision matrix \tilde{X} is expressed as:

$$\tilde{X} = [ \begin{matrix}( {μ}_{11} , {v}_{11} , {π}_{11} ) & ( {μ}_{12} , {v}_{12} , {π}_{12} ) & … & ( {μ}_{1 n} , {v}_{1 n} , {π}_{1 n} ) \\ ( {μ}_{21} , {v}_{21} , {π}_{21} ) & ( {μ}_{22} , {v}_{22} , {π}_{22} ) & … & ( {μ}_{2 n} , {v}_{2 n} , {π}_{2 n} ) \\ … & … & ⋱ & … \\ ( {μ}_{m 1} , {v}_{m 1} , {π}_{m 1} ) & ( {μ}_{m 2} , {v}_{m 2} , {π}_{m 2} ) & … & ( {μ}_{mn} , {v}_{mn} , {π}_{mn} )\end{matrix} ]$$

In the formula, \tilde{X} denotes an aggregation intuitionistic fuzzy matrix. (μₘₙ, νₘₙ, πₘₙ) denotes a direct fuzzy number corresponding to to-be-assessed technology m and assessment index n after aggregation.
4) Objective weight is calculated. The calculation formula of the objective weight is as follows:

$${E}_{j} = \frac{1}{m} {\sum }_{i = 1}^{m} cos \frac{π ( {μ}_{ij} - {v}_{ij} ) ( 1 - {π}_{ij} )}{2} , j = 1 , 2 , … , n \\ {W}^{″} = \frac{1 - {E}_{j}}{n - {\sum }_{j = 1}^{n} {E}_{j}} , j = 1 , 2 , … , n$$

In the formula, Eⱼ denotes the intuitionistic fuzzy entropy of the jth second level index. μᵢⱼ denotes the membership degree of the intuitionistic fuzzy number of the jth second level index corresponding to the ith first level index of the aggregation fuzzy matrix. Similarly, νᵢⱼ and πᵢⱼ denote the non-membership degree and the hesitation degree respectively. m denotes the total number of first level indexes. W″ denotes objective index weight.

For the combined weighting method based on the game theory, the process may be as follows: The weight of eight indexes is determined by two methods, and the index weight determined by the two methods is expressed in a vector form. The formula is as follows:

$${W}_{q} = ( {W}_{q 1} , {W}_{q 2} , … , {W}_{ql} ) , q = 1 , 2 , … , l$$

In the formula, W_{q} denotes the index vector determined by the qth method. W_{ql} denotes the lth index weight determined by the qth method. The linear combination of two weight vectors W_{q} is expressed as: W=αW′+βW″. W′ denotes a subjective weight vector built by the SWARA method. W″ denotes an objective weight vector built by the intuitionistic fuzzy entropy weight method. α and β denote a subjective weight coefficient and an objective weight coefficient respectively.

A game theory combination principle is used to solve α and β. The formula is as follows:

$$( \begin{matrix}{W}^{′} {W}^{′ T} & {W}^{′} {W}^{″ T} \\ {W}^{″} {W}^{′ T} & {W}^{″} {W}^{″ T}\end{matrix} ) [ \begin{matrix}{α}_{1} \\ {α}_{2}\end{matrix} ] = [ \begin{matrix}{W}^{′} {W}^{′ T} \\ {W}^{″} {W}^{″ T}\end{matrix} ] ; α + β = 1$$

In an embodiment, a two-dimensional similarity calculation is performed on the risk cloud and the standard cloud to obtain the two-dimensional similarity between the risk cloud and the standard cloud in the following manners: A two-dimensional normal cloud model of the standard cloud is generated according to the occurrence probability level, the consequence level, and the membership degree of the windage yaw flashover of the standard cloud, and a two-dimensional normal cloud model of the risk cloud is generated according to the occurrence probability level, the consequence level, and the membership degree of the windage yaw flashover of the risk cloud; and cloud model similarity calculation is performed according to the two-dimensional normal cloud model of the standard cloud and the two-dimensional normal cloud model of the risk cloud to obtain the two-dimensional similarity between the risk cloud and the standard cloud.

In the practical application, a cloud model is a qualitative and quantitative analysis method, which can better analyze the randomness, fuzziness, and uncertainty of an assessment object. In quantitative theory domain U, there are N qualitative concepts. If there is a quantitative value x∈N, x is called a random probability manifestation of qualitative concept N. The degree of membership μ(x)∈[0, 1] of x to N is a random number having a stable tendency. x is called a cloud droplet. The distribution of x in U theory domain is called a cloud. The digital characteristic of a cloud may reflect the overall characteristic of the cloud. The digital characteristic includes expectation Ex, entropy En and hyperentropy He. Ex can reflect the position of the cloud gravity center. En can reflect the dispersion degree of a cloud droplet and the uncertainty of a qualitative concept. The greater En is, the higher the uncertainty is, and the greater the fuzziness and randomness are. He is directly related to the distance between cloud droplets and the thickness of a cloud droplet.

A two-dimensional cloud is developed on the basis of a one-dimensional cloud. On the basis that in the one-dimensional cloud, a qualitative property and a quantitative property can be combined, and randomness and fuzziness can be integrated, a more systematic and higher-level tool is provided, and a method for dealing with more complex problems can be provided. The two-dimensional cloud can be used to describe a problem caused by the joint action of two factors. The severity of the power transmission line windage yaw flashover is determined by the consequence level of a risk factor and the probability level of occurrence of an incident, which is consistent with the concept of the two-dimensional cloud. Thus, it is scientific and meaningful to use the two-dimensional cloud to establish a power transmission line windage yaw flashover assessment model.

The model uses three digital characteristics: expectation Ex, entropy En, and hyperentropy He to represent a qualitative concept. Expectation Ex is an ideal average point for quantification of a qualitative problem and the center point of the distribution of a cloud droplet in a theory domain.

For the standard cloud, the occurrence probability and occurrence consequence of each index are divided into five levels for the division standard of a risk level, and the risk level interval thereof is quantized. In addition, a standard cloud composed of five two-dimensional clouds is established by using the maximum value Rₘₐₓ and the minimum value Rₘᵢₙ of each risk level quantization interval, and the standard cloud is used as the reference standard for the risk cloud. The risk description and digital characteristic of each level are shown in Table 2.

TABLE 2
Risk level quantification criteria

| | Probability | Consequence | | Standard | |
|---|---|---|---|---|---|
| | Level | Level | Risk Level | Cloud Digital | Risk Level |
| Risk Level | Description | Description | Interval | Characteristic | Description |
| I low risk | almost never | minimal | [0, 1.6) | (0.8, 0.27, 0.4) | negligible risk |
| | occur | hazard | | | |
| II lower risk | less likely to | minor hazard | [1.6, 4.8) | (3.2, 0.53, 04) | acceptable |
| | occur | | | | risk |
| III medium | likely to | medium | [4.8, 7.6) | (6.2, 0.47, 04) | acceptable |
| risk | occur | hazard | | | risk after |
| | | | | | being repaired |
| IV higher | more likely to | greater hazard | [7.6, 8.8) | (8.2, 0.2, 0.4) | unacceptable |
| risk | occur | | | | risk, |
| | | | | | rectification |
| V high risk | very likely to | extreme | [8.8, 10] | (9.4, 0.2, 0.4) | unacceptable |
| | occur | hazard | | | risk, |
| | | | | | deactivation |

Thus, the calculation formula for drawing the three parameters of the standard cloud model is as follows:

$$\{ \begin{matrix}Ex = ( {E}_{max} + {E}_{min} ) / 2 \\ En = ( {R}_{max} - {R}_{min} ) / 6 \\ He = k\end{matrix}$$

In the formula, k denotes a constant and is selected according to the fuzzy threshold of a variable. k is usually taken as 0.01, 0.5, and 1. In the present application, k is taken as 0.01. If there is only a single side constraint, such as [Rₘᵢₙ, +∞) or (−∞, Rₘₐₓ], the maximum or minimum value of sample data should be used as a threshold to supplement the single side and then use the preceding formula to calculate the risk level threshold interval, such as [Lₘᵢₙ, Lₘₐₓ], corresponding to the present application.

For the risk cloud (initial risk cloud), the data used for the risk cloud is the value of each index scored by each expert. The calculation formula is as follows:

$$Ex = \overline{w} = \frac{1}{n} {\sum }_{i = 1}^{n} {x}_{i} \\ {E}_{n} = \sqrt{\frac{π}{2}} \times {M}_{1} = \frac{1}{n} \sqrt{\frac{π}{2}} {\sum }_{i = 1}^{n} \vert {x}_{i} - \overline{x} \vert \\ He = \sqrt{\vert {S}^{2} - {En}^{2} \vert} = \sqrt{\frac{1}{n - 1} {\sum }_{i = 1}^{n} {( {x}_{i} - \overline{x} )}^{2} - {En}^{2}}$$

In the formula, Ex denotes the expectation of the risk cloud. Eₙ denotes the entropy of the risk cloud. He denotes the hyperentropy of the risk cloud. w̅, M, and S denote the sample average value, the sample first-order absolute center moment, and the sample variance of each expert's score of each index respectively. xᵢ denotes a sample observation value, corresponding to the expert's score. n denotes the number of samples, corresponding to the number of experts. Entropy Eₙ is a quantization interval that represents a qualitative concept and is the deviation between actuality and expectation, and reflects the fuzziness of information. The hyperentropy He is the entropy of Eₙ, which reflects the randomness of information and is reflected in a cloud chart as the tightness of cloud droplet condensation.

The weight of indexes at all levels obtained through reconciliation based on the game theory is converted from a second level index to a first level index, thereby obtaining the comprehensive risk cloud of the assessment object. The calculation formula is as follows:

$$C = ( {w}_{1} , {w}_{2} , … , {w}_{n} ) [ \begin{matrix}{E}_{{x}_{1}} & {E}_{{n}_{1}} & {H}_{{e}_{1}} \\ ⋮ & ⋮ & ⋮ \\ {E}_{{x}_{n}} & {E}_{{n}_{n}} & {H}_{{e}_{n}}\end{matrix} ] = ( {E}_{x}^{′} , {E}_{n}^{′} , … , {H}_{e}^{′} )$$

In the formula, C denotes the digital characteristic of the comprehensive risk cloud. Eₓ′, Eₙ′, Hₑ′ denote the expectation, entropy, and hyperentropy of the comprehensive cloud respectively. wn denotes the weight of each index after being reconciled by the game method, and n denotes the nth index. For example, there are three indexes having comprehensive weights of 0.2, 0.5, and 0.3 respectively, and then here w=(0.2, 0.5, 0.3). Eₓ_{ₙ}, Eₙ_{ₙ}, Hₑ_{ₙ} denote the expectation, entropy, and hyperentropy of the nth second index.

For a normal cloud model, the normal cloud model is also divided into a one-dimensional normal cloud model, a two-dimensional normal cloud model, and an n-dimensional normal cloud model according to a theory domain dimension. Different from the one-dimensional normal cloud model, the two-dimensional normal cloud model is built from two sets of digital characteristics (Eₓ, Eₙ, Hₑ) representing two qualitative concepts, which are used to describe the randomness and fuzziness under the joint action of two factors. The function of this model is to convert three data expectation, entropy, and hyperentropy obtained from a preamble standard cloud and risk cloud into cloud droplets through the repetition of the formula below. The formula is as follows:

$$\{ \begin{matrix}( {x}_{i} , {y}_{i} ) = F ( {E}_{{x}_{x}} , {E}_{{x}_{y}} , {E}_{{n}_{x}} , {E}_{{n}_{y}} ) \\ ( {p}_{xi} , {p}_{yi} ) = F ( {E}_{{n}_{x}} , {E}_{{n}_{y}} , {H}_{{e}_{x}} , {H}_{{e}_{y}} ) \\ {μ}_{i} = exp \{ - \frac{1}{2} [ \frac{{( {x}_{i} - {E}_{{x}_{x}} )}^{2}}{{p}_{xi}^{2}} + \frac{{( y - {E}_{{x}_{y}} )}^{2}}{{p}_{yi}^{2}} ] \}\end{matrix}$$

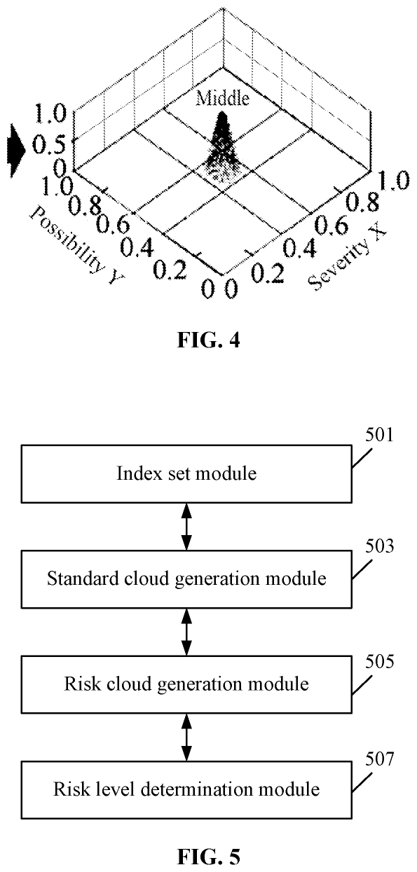

In the formula, Eₓ_{ₓ} and Eₓ_{_{y}} denote the expected values generated by an occurrence probability level risk cloud and an occurrence consequence level risk cloud respectively. Eₙ_{ₓ} and Eₙ_{_{y}} denote the standard deviations of the occurrence probability level risk cloud and the occurrence consequence level risk cloud respectively. Hₑ_{ₓ} and Hₑ_{_{y}} denote the hyperentropy of the occurrence probability level risk cloud and the occurrence consequence level risk cloud. μᵢ denotes the membership degree function of a two-dimensional cloud model. F denotes a two-dimensional random function subject to normal distribution. Here, i denotes the sequence numbers of the cloud droplets generated one by one. A large number of two-dimensional cloud droplets emerging in a number field are condensed into a two-dimensional normal cloud. (xᵢ, yᵢ) denotes the coordinate of the x-axis and y-axis generated by the ith cloud droplet. (pₓᵢ,p_{yi}) denotes the random number generated by the ith cloud droplet. The preceding formula is satisfied as a cloud droplet (xᵢ, yᵢ, μᵢ), and the preceding formula is repeated. When the number of cloud droplets is sufficient, a two-dimensional cloud model is formed. The occurrence probability level of windage yaw flashover is set as the Y-axis, and the consequence level is set as the X-axis. The degree of membership is set as the Z-axis. The diagram is shown in FIG. 4.

When the similarity of a cloud model is determined, the quantitative comparison of the similarity between the two cloud charts is called the similarity determination of the cloud model. A risk level is determined by using a two-dimensional cloud similarity calculation method. The calculation formula is as follows:

$$L = \frac{1}{\sqrt{{( \overline{Ex} - Ex )}^{2} + {( \overline{{Ex}^{′}} + {Ex}^{′} )}^{2}}}$$

In the formula, L denotes the similarity. E̅x̅, Ex, Ex′, and E̅x̅′̅ denote the expected value of the incident occurrence probability standard cloud of windage yaw flashover, the expected value of the incident occurrence probability actual cloud of the windage yaw flashover, the expected value of the incident occurrence consequence level standard cloud of the windage yaw flashover, and the expected value of the occurrence consequence level actual cloud of the windage yaw flashover respectively.

The technical solutions provided in the embodiments of the present application may include the following beneficial effects: In the present application, the risk assessment indexes are determined according to the influence factors, so that the assessment of the windage yaw flashover is more universal. The two-dimensional normal cloud model is generated through the standard cloud and the risk cloud. A risk value is determined according to the two-dimensional similarity of the two-dimensional normal cloud model. In this manner, the occurrence possibility and the occurrence consequence are considered, the index risk level boundary fuzziness is fully considered, and the assessment result is more reasonable. At the same time, the result is output in the form of a cloud chart, and the visualization degree of the risk level is high.

In addition, in the present application, when the risk cloud is determined, the assessment object is weighted by the SWARA method and the intuitionistic fuzzy entropy weight method, and the combined weighting method based on the game theory, and the assessment result is more balanced. Expert opinions and objective conditions are fully combined, so that the two-dimensional cloud model drawn on this basis is more accurate, and the deviation rate is smaller.

FIG. 5 shows an embodiment of a risk assessment system for power transmission line windage yaw flashover according to the present application.

In this optional embodiment, the risk assessment system for power transmission line windage yaw flashover includes an index set module 501, a standard cloud generation module 503, a risk cloud generation module 505, and a risk level determination module 507.

The index set module 501 is configured to determine the influence factors of the power transmission line windage yaw flashover and set the risk assessment indexes according to the influence factors.

The standard cloud generation module 503 is configured to generate the standard cloud of the risk assessment indexes according to the incident occurrence probabilities and the consequence levels of the risk assessment indexes.

The risk cloud generation module 505 is configured to score the influence factors according to the risk assessment indexes and generate the risk cloud of the risk assessment indexes according to the scoring results.

The risk level determination module 507 is configured to perform a two-dimensional similarity calculation on the risk cloud and the standard cloud to obtain the two-dimensional similarity between the risk cloud and the standard cloud and determine the risk level of the power transmission line windage yaw flashover according to the two-dimensional similarity.

Accordingly, in an embodiment, the index set module 504 is configured to determine the influence factors of the power transmission line windage yaw flashover according to the historical fault information, operation and maintenance information, and meteorological information of the power transmission line when the influence factors of the transmission line windage yaw flashover are determined. Accordingly, in an embodiment, the index set module 504 is configured to determine the influence factors of the power transmission line windage yaw flashover according to the historical fault information, operation and maintenance information, and meteorological information of the power transmission line when the influence factors of the transmission line windage yaw flashover are determined. The risk cloud generation module 505 includes a weight value calculation sub-module, an initial risk cloud generation sub-module, and a risk cloud generation sub-module. The weight value calculation sub-module is configured to generate the expert assessment system according to the risk assessment indexes and calculate the weight values of the risk assessment indexes according to the expert assessment system. The initial risk cloud generation sub-module is configured to assess the risk assessment indexes according to the expert assessment system and generate the initial risk cloud of the risk assessment indexes according to the assessment results. The risk cloud generation sub-module is configured to generate the risk cloud of the risk assessment indexes according to the weight values and the initial risk cloud.

Accordingly, in an embodiment, the weight value calculation sub-module includes a subjective weight value calculation unit. The subjective weight value calculation unit is configured to sort the risk assessment indexes according to the expert assessment system and perform comparing according to the risk assessment indexes of adjacent sequence numbers to obtain the comparison results; and determine the subjective weight values of the risk assessment indexes based on the stepwise weight assessment ratio analysis method according to the comparison results. The objective weight value calculation sub-module is configured to assess the risk assessment indexes according to the expert assessment system to obtain the assessment results; and convert the assessment results into the intuitionistic fuzzy numbers and calculate the objective weight values of the risk assessment indexes based on the direct fuzzy entropy weight method. The comprehensive weight value calculation sub-module is configured to determine the comprehensive weight values of the risk assessment indexes by the combined weighting method based on the game theory according to the subjective weight values and the objective weight values and use the comprehensive weight values as the weight values of the risk assessment indexes.

Accordingly, in an embodiment, the risk level determination module 507 includes a two-dimensional normal cloud model generation sub-module and a two-dimensional similarity calculation sub-module. The two-dimensional normal cloud model generation sub-module is configured to generate the two-dimensional normal cloud model of the standard cloud according to the occurrence probability level, the consequence level, and the membership degree of the windage yaw flashover of the standard cloud and generate the two-dimensional normal cloud model of the risk cloud according to the occurrence probability level, the consequence level, and the membership degree of windage yaw flashover of the risk cloud. The two-dimensional similarity calculation sub-module is configured to perform cloud model similarity calculation according to the two-dimensional normal cloud model of the standard cloud and the two-dimensional normal cloud model of the risk cloud to obtain the two-dimensional similarity between the risk cloud and the standard cloud.

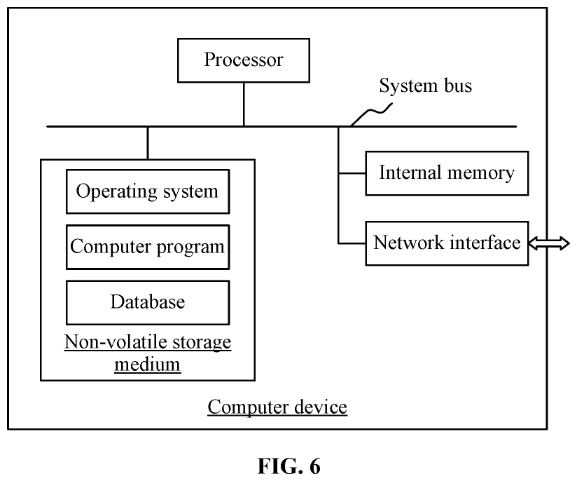

In an embodiment, a computer device is provided, which may be a server. An internal structure diagram of the computer device may be as shown in FIG. 6. The computer device includes a processor, a memory, and a network interface which are connected via a system bus. The processor of the computer device is configured to provide computing and control capabilities. The memory of the computer device includes a non-volatile storage medium and an internal memory. The non-volatile storage medium stores an operating system, computer programs, and a database. The internal memory provides an environment for running the computer programs and the operating system in the non-volatile storage medium. The database of the computer device is configured to store static information data and dynamic information data. The network interface of the computer device is configured to communicate with an external terminal through a network connection. When executing the computer programs, a processor performs steps of the preceding method embodiments.

It is to be understood by those skilled in the art that the structure illustrated in FIG. 6 is merely a block diagram of a part of structures related to the solutions of the present application and does not limit the computer device to which the solutions of the present application are applied, and a specific computer device may include more or fewer components than those illustrated in the figure, or may be a combination of some components, or may have different layout of components.

A computer device is provided in an embodiment and includes a memory and a processor. The memory stores computer programs. When executing the computer programs, the processor performs steps of the preceding method embodiments.

In an embodiment, a computer-readable storage medium is provided. The storage medium stores a computer program. When executing the computer programs, the processor performs steps of the preceding method embodiments.

It is to be understood by those having ordinary skill in the art that all or part of the processes in the methods of the embodiments described above may be completed by instructing related hardware through computer programs, the computer programs may be stored in a non-volatile computer-readable storage medium, and during the execution of the computer programs, the processes in the method embodiments described above may be included. All references to the memory, storage, database, or other media used in the various embodiments provided in the present application may each include at least one of a non-volatile or a volatile memory. The non-volatile memory may include a read-only memory (ROM), a magnetic tape, a floppy disk, a flash, and an optical memory. The volatile memory may include a random access memory (RAM) or an external cache memory. By way of illustration but not limitation, the RAM may be in a variety of forms, such as a static random-access memory (SRAM) or a dynamic random-access memory (DRAM).

In summary, the occurrence probability level and the consequence level of a risk involve the quantitative interval division of concepts, which is the core of qualitative and quantitative transformation. Whether the interval division is reasonable directly affects the accuracy of conversion. In the present application, the risk levels of the two uncertain factors (consequence level and occurrence probability level) of the power transmission line windage yaw flashover are divided into five levels. The cloud model parameter at each level is calculated by using a formula. Then a risk standard cloud chart may be obtained by substituting a normal cloud model formula.

In Table 2, the qualitative description of the occurrence probability level and consequence level of each risk level corresponds to the respective risk level threshold and cloud model parameter. For example, the number of occurrences of possibility level I is almost zero, and the corresponding risk level threshold is [0, 1.6). Similarly, the risk level threshold corresponding to the qualitative description of consequence level I is also [0, 1.6). Each risk level threshold has a corresponding cloud model parameter, so that the probability level and the consequence level in a risk matrix may be superimposed in a manner of a two-dimensional cloud model. In this manner, the two-dimensional cloud model can be used to quantify the risk matrix. The possibility of an accident is determined by the order of magnitude of the possibility of the accident. Experts score an accident consequence level according to the corresponding risk level threshold according to the actual experience and the related theoretical analysis. The score of each expert on the incident consequence level is integrated to generate a consequence level cloud model. Then, the corresponding risk level threshold is scored for the accident probability according to the occurrence probability in Table 1. Each expert's score on the occurrence probability is integrated to generate an occurrence probability cloud model.

Finally, the weight obtained by improving the weighting method is used to bring the consequence level cloud model and the occurrence probability cloud model into a normal cloud model formula to generate a windage yaw flashover comprehensive cloud model, and then bring the consequence level cloud model and the occurrence probability cloud model into the two-dimensional cloud proximity calculation to determine the risk level.

What is claimed is:

1. A risk assessment method for power transmission line windage yaw flashover, comprising:
determining influence factors of power transmission line windage yaw flashover and setting risk assessment indexes according to the influence factors;
generating a standard cloud of the risk assessment indexes according to incident occurrence probabilities and consequence levels of the risk assessment indexes;
scoring the influence factors according to the risk assessment indexes and generating a risk cloud of the risk assessment indexes according to scoring results; and
performing a two-dimensional similarity calculation on the risk cloud and the standard cloud to obtain two-dimensional similarity between the risk cloud and the standard cloud and determining a risk level of the power transmission line windage yaw flashover according to the two-dimensional similarity.

2. The risk assessment method for power transmission line windage yaw flashover according to claim 1, further comprising:
determining the influence factors of the power transmission line windage yaw flashover according to historical fault information, operation and maintenance information, and meteorological information of a power transmission line.

3. The risk assessment method for power transmission line windage yaw flashover according to claim 1, wherein scoring the influence factors according to the risk assessment indexes and generating the risk cloud of the risk assessment indexes according to the scoring results comprise:
generating an expert assessment system according to the risk assessment indexes and calculating weight values of the risk assessment indexes according to the expert assessment system;
assessing the risk assessment indexes according to the expert assessment system and generating an initial risk cloud of the risk assessment indexes according to assessment results; and
generating the risk cloud of the risk assessment indexes according to the weight values and the initial risk cloud.

4. The risk assessment method for power transmission line windage yaw flashover according to claim 3, wherein calculating the weight values of the risk assessment indexes according to the expert assessment system comprises:
sorting the risk assessment indexes according to the expert assessment system and performing comparing according to risk assessment indexes of adjacent sequence numbers to obtain comparison results; and
determining subjective weight values of the risk assessment indexes based on a stepwise weight assessment ratio analysis method according to the comparison results.

5. The risk assessment method for power transmission line windage yaw flashover according to claim 4, wherein calculating the weight values of the risk assessment indexes according to the expert assessment system further comprises:
assessing the risk assessment indexes according to the expert assessment system to obtain the assessment results; and
converting the assessment results into intuitionistic fuzzy numbers and calculating objective weight values of the risk assessment indexes based on a direct fuzzy entropy weight method.

6. The risk assessment method for power transmission line windage yaw flashover according to claim 5, wherein calculating the weight values of the risk assessment indexes according to the expert assessment system further comprises:
determining comprehensive weight values of the risk assessment indexes by a combined weighting method based on a game theory according to the subjective weight values and the objective weight values; and
using the comprehensive weight values as the weight values of the risk assessment indexes.

7. The risk assessment method for power transmission line windage yaw flashover according to claim 1, wherein performing the two-dimensional similarity calculation on the risk cloud and the standard cloud to obtain the two-dimensional similarity between the risk cloud and the standard cloud comprises:
generating a two-dimensional normal cloud model of the standard cloud according to an occurrence probability level, a consequence level, and a membership degree of windage yaw flashover of the standard cloud and generating a two-dimensional normal cloud model of the risk cloud according to an occurrence probability level, a consequence level, and a membership degree of windage yaw flashover of the risk cloud; and
performing cloud model similarity calculation according to the two-dimensional normal cloud model of the standard cloud and the two-dimensional normal cloud model of the risk cloud to obtain the two-dimensional similarity between the risk cloud and the standard cloud.

8-14. (canceled)

15. A computer device, comprising a memory and a processor, wherein the memory stores computer programs, and when executing the computer programs, the processor performs:
determining influence factors of power transmission line windage yaw flashover and setting risk assessment indexes according to the influence factors;
generating a standard cloud of the risk assessment indexes according to incident occurrence probabilities and consequence levels of the risk assessment indexes;
scoring the influence factors according to the risk assessment indexes and generating a risk cloud of the risk assessment indexes according to scoring results; and
performing a two-dimensional similarity calculation on the risk cloud and the standard cloud to obtain two-dimensional similarity between the risk cloud and the standard cloud and determining a risk level of the power transmission line windage yaw flashover according to the two-dimensional similarity.

16. A non-transitory computer-readable storage medium, storing computer programs, wherein when executing the computer programs, a processor performs steps of the method according to claim 1.

17. The computer device according to claim 15, wherein when executing the computer programs, the processor performs:
determining the influence factors of the power transmission line windage yaw flashover according to historical fault information, operation and maintenance information, and meteorological information of a power transmission line.

18. The computer device according to claim 15, wherein scoring the influence factors according to the risk assessment indexes and generating the risk cloud of the risk assessment indexes according to the scoring results comprise:
generating an expert assessment system according to the risk assessment indexes and calculating weight values of the risk assessment indexes according to the expert assessment system;
assessing the risk assessment indexes according to the expert assessment system and generating an initial risk cloud of the risk assessment indexes according to assessment results; and
generating the risk cloud of the risk assessment indexes according to the weight values and the initial risk cloud.

19. The computer device according to claim 18, wherein calculating the weight values of the risk assessment indexes according to the expert assessment system comprises:
sorting the risk assessment indexes according to the expert assessment system and performing comparing according to risk assessment indexes of adjacent sequence numbers to obtain comparison results; and
determining subjective weight values of the risk assessment indexes based on a stepwise weight assessment ratio analysis method according to the comparison results.

20. The computer device according to claim 19, wherein calculating the weight values of the risk assessment indexes according to the expert assessment system further comprises:
assessing the risk assessment indexes according to the expert assessment system to obtain the assessment results; and
converting the assessment results into intuitionistic fuzzy numbers and calculating objective weight values of the risk assessment indexes based on a direct fuzzy entropy weight method.

21. The computer device according to claim 20, wherein calculating the weight values of the risk assessment indexes according to the expert assessment system further comprises:
determining comprehensive weight values of the risk assessment indexes by a combined weighting method based on a game theory according to the subjective weight values and the objective weight values; and
using the comprehensive weight values as the weight values of the risk assessment indexes.

22. The computer device according to claim 15, wherein performing the two-dimensional similarity calculation on the risk cloud and the standard cloud to obtain the two-dimensional similarity between the risk cloud and the standard cloud comprises:
generating a two-dimensional normal cloud model of the standard cloud according to an occurrence probability level, a consequence level, and a membership degree of windage yaw flashover of the standard cloud and generating a two-dimensional normal cloud model of the risk cloud according to an occurrence probability level, a consequence level, and a membership degree of windage yaw flashover of the risk cloud; and
performing cloud model similarity calculation according to the two-dimensional normal cloud model of the standard cloud and the two-dimensional normal cloud model of the risk cloud to obtain the two-dimensional similarity between the risk cloud and the standard cloud.
